(19) United States
(12) Patent Application Publication
(10) Pub. No.: US 2005/0031769 A1
(43) Pub. Date: Feb. 10, 2005

(54) Dry powder which retains savor and flavor and method for producing the same

(75) Inventors: Aiji Watanabe, Kawasaki-shi (JP); Junichi Katouno, Kawasaki-shi (JP); Teruo Yoshida, Kawasaki-shi (JP); Susumu Tsujimoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO, CO., INC., Tokyo (JP)

(21) Appl. No.: 10/920,205

(22) Filed: Aug. 18, 2004

Related U.S. Application Data
(63) Continuation of application No. PCT/JP03/01197, filed on Feb. 5, 2003.

(30) Foreign Application Priority Data
Feb. 18, 2002 (JP) 040493/2002
Jul. 10, 2002 (JP) 201847/2002

(51) Int. Cl. B29B 9/00; A23F 5/00

(52) U.S. Cl. 426/640; 264/5

(57) ABSTRACT

In order to provide a spray dry method capable of producing a dry powder retaining the savor and flavor of a raw material and having solubility without any thermal deterioration, at a mass scale, a method for producing a dry powder keeping savor and flavor from a hydrous liquid material containing a savory and flavorful component and, preferably, a hygroscopic component by spray drying is disclosed, the method including spray drying the hydrous liquid material at the microfine liquid droplet state in gas atmosphere at the outlet temperature of a spray dryer at 20 to 90° C. and the outlet relative humidity of 1% RH to 40% RH, to prepare a dry powder of a mean particle size of 0.1 μm to 15 μm.

### CROSS REFERENCES TO RELATED APPLICATIONS

This application is a continuation of International Patent Application No. PCT/JP03/01197, filed on Feb. 5, 2003, and claims priority to Japanese Patent Application No. 040493/2002, filed on Feb. 18, 2002, and Japanese Patent Application No. 201847/2002, filed on Jul. 10, 2002, all of which are incorporated herein by reference in their entireties.

### BACKGROUND OF THE INVENTION

1. Field of the Invention

The present invention relates to methods for producing a dry powder which contains a savory and flavorful component and which may preferably contain a hygroscopic component. The present invention also relates to the powders produced by such methods.

2. Discussion of the Background

In the food field, traditionally, the spray drying method has been used, along with the freeze-drying method, the vacuum continuous belt drying method, and the reduced pressure-low temperature drying method with a vacuum dry dryer, as a method for producing dry powders which keep and retain the savor and flavor of ingredients such as, for example, dry extracts of animals and plants.

Generally, the spray drying method includes preparing a solution or a slurry of particles into the form of microfine particles in hot air and then dispersing the particles therein, to prepare a dry powder of spherical and spherical shell-like powders. Pressure nozzles, rotary disks, two-fluid nozzles, and the like are used as the spraying unit. In many cases, the mean particle size (diameter) of the resulting dry powder is about 20 μm to 500 μm, and the drying time is as short as 5 seconds to 30 seconds (see, Handbook of Chemistry and Engineering, revised sixth edition, p. 770, p. 780 (1999), issued by Maruzen). In recent years, additionally, a four-fluid nozzle has been developed, which has enabled mass-scale spray drying with a liquid droplet having a mean particle size of several micrometers (see, Chemical Apparatus, pp. 60-65 (June, 2000)).

The spray drying method is used in many cases for the aim of mass scale production. To produce a large volume of powder in a short period of time, generally, a sample solution is fed at a fast feed rate into a spray dryer, while the inlet temperature of the spray dryer and the outlet temperature thereof are elevated as high as possible, to dry the sample solution at a high speed. For example, milk is dried at an inlet temperature of the spray dryer of 150 to 250° C. (see, Spray Drying Handbook, p. 606). Yeast is dried at the inlet temperature of 300 to 350° C. (see, Spray Drying Handbook, pp. 656-657). Drying at such high temperatures scatters the savor and flavor of the raw material itself and produces a dry powder with a burned odor. However, spray drying at a low temperature to avoid these disadvantages leads to a severe reduction in the productivity and causes the cost to go up, disadvantageously.

For the production of a dry powder from a hydrous liquid material containing a savory or flavorful component and, preferably, a hygroscopic component by spray drying in such manner, it is desired that: (a) mass scale production is possible; (b) the savory and flavorful component is retained; (c) thermal deterioration such as a burned odor or browning never occurs; and (d) the resulting dry powder has a high solubility. However, no method satisfying all of these requirements has been found.

For dilute solutions (1 wt. % to 7.8 wt. %) of pharmaceutical products, such as interferon, it is disclosed that feeding the solutions to a spray dryer (nozzle diameters of 0.4 mm and 0.7 mm) under conditions of an inlet temperature of 50° C. or less and an outlet temperature of 35° C. or less (estimated) can yield a powder with the maximum powder particle size (diameter) of about 3 μm to 6 μm, so that the resulting pharmaceutical powders exhibit a slow dissolution rate and retain their physiological activities (see, JP-A-11-114027). However, JP-A-11-114027 does not disclose any description as to the properties of the dry air used in the spray dryer or any description of any specific dehumidifying conditions or the use of dehumidified air. Therefore, the term dry air is interpreted simply as the air use for drying.

Further, Birs Beteiligungs und Verwaltu carried out drying under dehumidifying and drying conditions at a low temperature, using a large vertical countercurrent spray dryer but never described the spray particle size (see, the specification of GBP 1 015 599). A subsequent report discloses that concentrated tomato juice is dried with dehumidified air at a low temperature of 18 to 26° C. and at 3% RH (relative humidity) or less in a spray dryer with a concrete tower of a diameter of about 15 m and a height of about 67 m, to obtain a powder of a particle size (diameter) of 80 μm to 100 μm. However, there is no production report of the preparation of microfine particles of a liquid having a droplet particle size (diameter) of 20 μm or less into a dry powder (including granulated powder).

### SUMMARY OF THE INVENTION

Accordingly, it is one object of the present invention to provide novel spray drying methods and spray drying granulation methods for producing a dry powder from a hydrous liquid material containing a savory and flavorful component and, preferably, a hygroscopic component.

It is another object of the present invention to provide novel spray drying methods and spray drying granulation methods for producing a dry powder from a hydrous liquid material containing a savory and flavorful component and, preferably, a hygroscopic component, in which the resulting powder retains and keeps the savor and flavor of the of the savory and flavorful component used as the raw or starting material.

It is another object of the present invention to provide novel spray drying methods and spray drying granulation methods for producing a dry powder from a hydrous liquid material containing a savory and flavorful component and, preferably, a hygroscopic component, in which the resulting powder is soluble.

It is another object of the present invention to provide novel spray drying methods and spray drying granulation methods for producing a dry powder from a hydrous liquid material containing a savory and flavorful component and, preferably, a hygroscopic component, which avoids or reduces the occurrence of thermal deterioration.

It is another object of the present invention to provide novel spray drying methods and spray drying granulation methods for producing a dry powder from a hydrous liquid material containing a savory and flavorful component and, preferably, a hygroscopic component, which can be practiced on a large scale.

It is another object of the present invention to provide novel powders produced by such methods.

These and other objects, which will become apparent during the following detailed description, have been achieved by the inventors' discovery that drying of soy sauce and soy sauce containing trehalose under dehumidified conditions at low temperature, using a spray dryer capable of preparing soy sauce and soy sauce containing trehalose into the form of liquid droplets (particle) having a mean particle size of several micrometers can yield a stable dry powder which keeps and retains the savor and flavor essential to soy sauce without any peculiar odor such as a burned odor and has a high solubility, with less occurrence of any browning reaction, and that the dry powder can be made instantly.

Thus, the present invention includes the following individual embodiments:
(1) A method for producing a dry powder which retains and keeps the savor and flavor of a savory and flavorful component from a hydrous liquid material which contains a savory and flavorful component by spray drying, the method comprising spray drying the hydrous liquid material in a microfine liquid droplet state in gas atmosphere with the outlet temperature of the spray dryer at 20 to 90° C. and an outlet relative humidity of 1% RH to 40% RH, to prepare a dry powder having a mean particle size (Mean Volume Diameter) of 0.1 μm to 15 μm.
(2) A method for producing a dry powder which retains and keeps the savor and flavor of a savory and flavorful component from a hydrous liquid material which contains a savory and flavorful component by spray drying, the method comprising spray drying the hydrous liquid material in a microfine liquid droplet state in gas atmosphere with the outlet temperature of the spray drying granulation apparatus at 20 to 90° C. and an outlet relative humidity of 1% RH to 40% RH, and granulating and drying the resulting dry material during spray drying or after spray drying, to prepare a dry powder having a mean particle size (Mean Volume Diameter) of 20 μm to 1,000 μm.
(3) A method for producing a dry powder which retains and keeps the savor and flavor of a savory and flavorful component from a hydrous liquid material which contains a savory and flavorful component by spray drying, the method comprising spray drying the hydrous liquid material in a microfine liquid droplet state in gas atmosphere with the outlet temperature of the spray drying granulation apparatus at 20 to 90° C. and an outlet relative humidity of 1% RH to 40% RH, granulating and drying the resulting dry material during spray drying or after spray drying, and subsequently finally drying the granulated material, to prepare a dry powder having a mean particle size (Mean Volume Diameter) of 20 μm to 1,000 μm.
(4) A method for producing a dry powder which retains and keeps the savor and flavor of a savory and flavorful component as described in (1) through (3), in which the hydrous liquid material is spray dried or spray dried and granulated in the presence of trehalose.
(5) A method for producing a dry powder which retains and keeps the savor and flavor of a savory and flavorful component as described in (4), in which the trehalose is added to the hydrous liquid material or the trehalose is prepared into the form of a trehalose solution in a microfine liquid droplet state to be fed to the spray dryer or the spray drying granulation apparatus.
(6) A method for producing a dry powder which retains and keeps the savor and flavor of a savory and flavorful component as described in any one of (1) through (5), in which the hydrous liquid material which contains a savory and flavorful component is at least one selected from the group consisting of moisture-containing food materials, drinks, liquid seasonings, curry-containing fluids, mustard-containing fluids, Japanese horseradish-containing fluids, garlic-containing fluids, and ginger-containing fluids.
(7) A method for producing a dry powder which retains and keeps the savor and flavor of a savory and flavorful component as described in (6), in which the liquid seasonings are soy sauce-based liquid seasonings.
(8) A method for producing a dry powder which retains and keeps the savor and flavor of a savory and flavorful component as described in any one of (1) through (5), in which the hydrous liquid material which contains a savory and flavorful component is a hydrous liquid material containing at least one component selected from the group consisting of citrus essential oils, plant essential oils, oily extracts and the oleoresins thereof, synthetic perfume compounds, and oily composite perfumes.
(9) A method for producing a dry powder which retains and keeps the savor and flavor of a savory and flavorful component as described in any one of (1) through (8), in which the outlet temperature of the spray dryer is 20 to 75° C.
(10) A method for producing a dry powder which retains and keeps the savor and flavor of a savory and flavorful component as described in any one of (1) through (9), in which the outlet relative humidity of the spray dryer is 3% RH to 20% RH.
(11) A method for producing a dry powder which retains and keeps the savor and flavor of a savory and flavorful component as described in any one of (1) through (9), in which the outlet relative humidity of the spray dryer is 6% RH to 10% RH.
(12) A dry powder produced by any of the methods described in any one of (1) through (11).

### DETAILED DESCRIPTION OF THE PREFERRED EMBODIMENTS

The various aspects of the present invention will now be described in detail.

Hydrous Liquid Material Containing a Savory and Flavorful Component:

The term “hydrous liquid material which contains a savory and flavorful component” as used in accordance with the present invention includes hydrous compositions which contain a savory and flavorful component. In a preferred embodiment, the hydrous liquid material also contains a hygroscopic component. The hygroscopic component may be the same as the savory and flavorful component or may be an additional component. Hydrous compositions in the solution state or particle slurry state or possibly prepared into solution state or particle slurry state are included.

In the food field, specifically, such hydrous liquid materials include moisture-containing food materials; drinks; liquid seasonings such as animal and plant extracts, for example chicken and cattle extracts such as chicken extract, pork extract and beef extract, fish and shellfish extracts such as oceanic bonito extract, dried and sliced oceanic bonito chips; seasoned fluid materials recovered via fermentation and enzyme reactions such as soy sauce and soybean paste; fluid materials or ground materials of agricultural products such as corn paste, squeezed citrus, and other fluid materials, extracts; and ground materials derived from various animals and plants and the like. When the hydrous liquid material is to be prepared into the form of a dry powder, preferably, the liquid material can be solidified under conditions of 20° C. and a relative humidity of 40% RH for 5 days. The invention is applicable to such liquid materials.

Furthermore, the term “the liquid material which contains a savory and flavorful component” also includes hydrous liquid materials containing flavorful components such as curry, mustard, Japanese horseradish, garlic, ginger, egg flavor, and vinegar.

For the purpose of retaining the savor and flavor of a material to be dried, traditionally, a relatively large amount of excipients (for example, dextrin, cyclodextrin, gelatin and the like) has been likely used. Under the spray dry conditions in accordance with the present invention, however, dry powders which retain the savor and flavor can be produced from “liquid materials with savor and flavor” at a high content of contaminants, without any addition of excipients. Specifically, pure soy sauce (solid content of about 42 w/w %) with absolutely no content of dextrin and the like can be produced as soy sauce powder on a mass scale (see, Example 1, below).

If necessary, further, additives, for example, seasonings such as sodium glutamate; sweeteners such as sugar and amino acid-based sweetener aspartame; various salts, spices, oils and fats (solid and liquid) for flavor and the like; preservatives and stabilizers; colorants; and perfume can be contained in “the liquid material which contains a savory and flavorful component,” so as to improve the savor and flavor and physico-chemical properties.

In the field of perfume, further, “the liquid material which contains a savory and flavorful component” includes essential oils of citrus (orange, lemon, lime, grape fruit, etc.); plant essential oils (peppermint oil, spearmint oil, flower essential oils, spice oils, etc.); oily extracts and oleoresins thereof; synthetic perfume compounds; oily composite perfume; and the like. It is needless to say that, like the food materials, various additives for example dextrin, sugar, lactose, emulsifiers, water-soluble hemicellulose, and fatty acid esters can be contained therein (see, the gazettes of Japanese Patent No. 3057133, JP-A-9-107911, JP-A-9-111284, JP-A-9-187249, JP-A-2000-217538, JP-A-2001-152179, and JP-A-2001-186858).

As to the concentration of“the liquid material which contains a savory and flavorful component” for use in accordance with the invention, any concentration thereof is satisfactory, at which the liquid material has a viscosity suitable for feeding into spray dryer and which can be prepared into the form of liquid droplets having a mean particle size (Mean Volume Diameter) of 0.1 μm or more to less than 20 μm. Therefore, the concentration can be appropriately selected, with respect to the combination of the liquid material concentration and the apparatus for particle preparation. For example, soy sauce at a solid concentration of 35 wt. % to 55 wt. % can be used suitably as the liquid material. When using spray nozzles, such as a three-fluid nozzle and a four-fluid nozzle, the viscosity of the liquid material is preferably 200 cps or less, and more preferably 80 cps or less. For a rotary atomizer (rotary disk), the viscosity is preferably 70,000 cps or less.

Apparatus in Relation with Spray Drying:

Commercially available spray dryers can be used as the spray dryer for use in accordance with the present invention. For example, a spray dryer with a vertical parallel flow function is preferable. Essentially, the spray dryer should be a system with a dehumidifying and drying function. As described below, for example, a spray dryer capable of blowing a high volume of dry gas dehumidified to 1% RH or less is particularly preferable as the dehumidifying apparatus. For a spray dryer with no dehumidifying and drying function, the spray dryer is inevitably arranged with, for example, a dry dehumidifier BX series manufactured by Munsters K.K., or a HCS series and HCP series manufactured by Nichias Corporation. Suitable spray dryers include the micromist dryer MD series and the hybrid granulator series manufactured by Fujisaki Electric Co., Ltd., the FSD spray dryer with internal fluid layer as manufactured by Niro Corporation, the fluid granulation spray dryer and L-8 type spray dryer manufactured by O-gawara Chemical Engineering Machine Corporation, and the DL-21 type and GB-21 type manufactured by Yamato Scientific Co., Ltd. (on a needed basis, spray dry granulation apparatus can be used, and therefore, it is also described.)

In accordance with the present invention, it is preferred to carry out the spray drying, using a sprayer capable of generating liquid droplets (particles) having a mean particle size (Mean Volume Diameter) of 0.1 μm or more to less than 20 μm. Specifically, it is preferred to carry out the spray drying, using a spray dryer or spray dry granulation apparatus with a spray nozzle capable of generating a large volume of liquid droplets having a mean particle size (Mean Volume Diameter) of 0.1 μm or more to less than 20 μm, preferably 0.1 μm to 10 μm, and more preferably 1 μm to 8 μm. When the liquid droplets are dried, a dry powder having a mean particle size (Mean Volume Diameter) of 0.1 μm to 15 μm, preferably 0.1 μm to 7 μm, and more preferably 0.7 μm to 6 μm is prepared. This is preferable with the respect to the retention of the savor and flavor, because such dry powders can be recovered by drying under low-temperature conditions for a short time. For example, the four-fluid nozzle manufactured by Fujisaki Electric Co., Ltd., which can spray a large volume (for example, 1 kg/min) of liquid droplets having a mean particle size (diameter) of several micrometers (see, U.S. Pat. No. 2,797,080; and Chemical Apparatus, 2000, No. 6, pp. 60-65) and the three-fluid nozzle manufactured by Fukusen Production Corporation, which can spray a large volume (for example, 150 g/min) of liquid droplets having a mean particle size of 1 μm to 10 μm (see, JP-B-63-5146) may be used. The four-fluid nozzle is particularly preferable because the nozzle can spray a large volume.

The spray dryer is more preferably an apparatus with a granulation function (spray drying granulation apparatus). Furthermore, the spray drying granulation apparatus is preferably equipped with a unit capable of finally drying the granulated material. In the case of a particle with a small specific gravity, in particular, a dry powder particle having a mean particle size (Mean Volume Diameter) of 0.1 μm to 15 μm disadvantageously involves difficulty in handling. Preferably, a granulation function is additionally arranged in the inside of the spray dryer or in a state in communication with the spray dryer. Appropriate conditions for the granulation size may satisfactorily be selected, depending on the need. For example, the granulation size (Mean Volume Diameter) is 20 μm to 1,000 μm, and preferably 20 μm to 500 μm. As to the start timing of granulation, satisfactorily, granulation is sometimes effected almost simultaneously with spray drying or in other cases, fluid granulation is effected after spray drying or both fluid granulation and spray drying are effected simultaneously. With the respect to the retention of savor and flavor, spray drying and granulation are preferably carried out almost simultaneously. Depending on the physico-chemical properties of a subject dry powder, the manner of spray drying and granulation may be decided on a case by case basis.

The operation conditions such as the drying temperature of the spray drying granulation apparatus and the relative humidity thereof will now be described. Among the operation conditions of the spray drying granulation apparatus, it is important to preset the outlet temperature of the spray dry granulation apparatus to 20 to 90° C. and the outlet relative humidity to 1% RH to 40% RH. Specifically, the conditions are as follows. The spray drying granulation apparatus for use in accordance with the present invention include for example the “Hybrid Granulator Series as granulation apparatus on filter cloth with spray drying function equipped” manufactured by Fujisaki Electric Co., Ltd. The inlet temperature of the spray drying granulation apparatus of the invention is 30 to 160° C., preferably 30 to 110° C., more preferably 40 to 100° C., and particularly preferably 40 to 90° C. The outlet temperature of the spray drying granulation apparatus of the invention is 20 to 90° C., preferably 20 to 75° C., more preferably 35 to 60° C., and particularly preferably 35 to 50° C. Furthermore, the inlet relative humidity of the spray drying granulation apparatus of the invention is 35% RH or less, preferably 15% RH or less, more preferably 7% RH or less, and most preferably 1% RH or less. The outlet relative humidity of the spray drying granulation apparatus is further 1% RH to 40% RH, preferably 3% RH to 20% RH, and more preferably 6% RH to 10% RH. In accordance with the present invention, herein, the outlet relative humidity of the spray drying granulation apparatus means the relative humidity in the vicinity of the powder collection part of the spray drying granulation apparatus. For the spray dryer of the vertical parallel flow type, the outlet relative humidity means the relative humidity (exhaust gas humidity) at the exhaust part thereof. For the “Hybrid Granulator Series HGL-130 as granulation apparatus on filter cloth with spray drying function equipped” manufactured by Fujisaki Electric Co., Ltd., for example, the outlet relative humidity means the relative humidity (exhaust gas humidity) in the vicinity of the filter cloth at the powder collection part of the apparatus. Final drying can be performed preferably either during granulation or after granulation.

Operation Conditions of Spray Dryer:

The operation conditions of the spray dryer, such as drying temperature and relative humidity are described for the present invention as follows. The outlet temperature of the spray dryer is set to 20 to 90° C., while the outlet relative humidity is set to 1% RH to 40% RH.

More specifically, the conditions are as follows. The inlet temperature of the spray dryer for use in accordance with the present invention is 50 to 120° C., preferably 50 to 100° C., more preferably 60 to 90° C., and particularly preferably 60 to 80° C. The outlet temperature of the spray dryer for use in accordance with the invention is 20 to 90° C., preferably 20 to 75° C., more preferably 35 to 60° C., and particularly preferably 35 to 50° C. In accordance with the invention, herein, the term “outlet temperature of the spray dryer” means the product temperature of the dry powder in the vicinity of the powder collection part of the spray dryer. For the spray dryer of the vertical parallel flow type, the outlet temperature means the temperature (exhaust gas temperature) at the exhaust part thereof. For the “Hybrid Granulator Series HGL-130 as granulation apparatus on filter cloth with spray drying function equipped” manufactured by Fujisaki Electric Co., Ltd., for example, the outlet temperature means the product temperature (exhaust gas temperature) of a product to be dried on the filter cloth at the powder collection part of the apparatus. An outlet temperature of the spray dryer less than 20° C. is not preferable with respect to productivity. An outlet temperature of more than 90° C. is not preferable, because the retained savor and flavor is often scattered under observation. The temperature range of 35 to 50° C. is particularly preferable, with the respect to the retention of savor and flavor and with the respect to productivity, for spray drying a liquid material containing a savory and flavorful component such as dried extracts and soy sauce and, preferably, a hygroscopic component.

Alternatively, the inlet relative humidity of the spray dryer of the present invention is 20% RH or less, preferably 15% RH or less, and more preferably 1% RH or less. The outlet relative humidity of the spray dryer of the invention as set in accordance with the invention is 1% RH to 40% RH, preferably 3% RH to 20% RH, and more preferably 6% RH to 10% RH. In accordance with the present invention, herein, the outlet relative humidity of the spray dryer means the relative humidity in the vicinity of the powder collection part of the spray dryer. For the spray dryer of the vertical parallel flow type, the outlet relative humidity means the relative humidity (exhaust gas humidity) at the exhaust part thereof. For the “Hybrid Granulator Series HGL-130 as granulation apparatus on filter cloth with spray drying function equipped” manufactured by Fujisaki Electric Co., Ltd., for example, the outlet relative humidity means the relative humidity (exhaust gas humidity) in the vicinity of the filter cloth at the powder collection part of the apparatus.

When soy sauce is to be dried by the spray drying method or the spray drying granulation method of the present invention, an outlet relative humidity of 15% RH or less, preferably 1% RH to 12% RH, and more preferably 1% RH to 10% RH is suitable for spray drying, but the outlet relative humidity varies due to the influence of additives. When it is intended to simultaneously carry out granulation, for the prevention of a fluffy powder state, the relative humidity is preferably 6% RH to 10% RH.

In the case of soy sauce, the temperature of the hot air inlet of the spray dryer is 50 to 200° C., and preferably 70 to 110° C., while the outlet temperature (exhaust gas) is 20 to 80° C., and preferably 30 to 50° C., with the respect to the retention of savor and flavor.

Particularly with the respect to the improvement of the productivity of dry powder, the volume of dry gas, for example dry air for use in accordance with the present invention is preferably 0.5 m/min or more, more preferably 1 m/min to 5 m/min, and still more preferably 1 m/min to 3.5 m/min. Herein, the volume of dry air means the air rate (m/min) in the spray dryer or at the cylinder part (the trunk part) of the body of the spray dry granulation apparatus. For the “Hybrid Granulator HGL-130 as granulation apparatus on filter cloth with spray drying function equipped” manufactured by Fujisaki Electric Co., Ltd., for example, the volume means the filtration rate. Further, the liquid feed rate of the liquid raw material can be preset appropriately, in relation with the inlet temperature, the outlet temperature, the exhaust gas humidity, the type of the liquid raw material, the desired particle size, and the like. Additionally, the spraying pressure is preferably 0.5 kg/cm² or more, more preferably 1 kg/cm² to 5 kg/cm², and still more preferably 1 kg/cm² to 3 kg/cm².

Furthermore, the gas to be used in accordance with the present invention may satisfactorily be a gas other than air, provided that the gas can satisfy the conditions described above. Inert gases, for example nitrogen gas and carbonate gas, can be used. For readily oxidizable substances, inert gases are preferred.

Trehalose:

By adding trehalose to the “liquid material which contains a savory and flavorful component” prior to spraying and the like and then spray drying the resulting mixture in accordance with the present invention, the resulting dry powder can retain the savor and flavor of the liquid material and is soluble but is hardly solidified. It has been known that trehalose has the following numerous advantages. Trehalose is distributed widely in naturally occurring materials such as mushrooms, beans, shrimps, seaweeds, and the like, and is one of sugars which has been traditionally ingested. Trehalose is hardly hygroscopic (for example, trehalose dihydrate is hardly hygroscopic, up to a relative humidity of 95% RH). Trehalose has the effect of preventing moisture evaporation. Trehalose has the effect on preventing protein modification and never causes Maillard's reaction (see “Treha” in the catalog of Hayashibara Co., Ltd.).

The trehalose for use in accordance with the invention includes α,α-trehalose, α,β-trehalose, and β,β-trehalose. The dihydrate of α,α-trehalose, now less expensive and naturally occurring, is preferable, because the dihydrate thereof is never hygroscopic over time. For example, a commercially available product “Treha” (Hayashibara Co., Ltd.) may be used.

For moisture-containing food materials, drinks, and liquid seasonings such as animal and plant extracts, the amount of trehalose to be added (on an anhydride basis) is such that the resulting dry powder may contain trehalose at 0.1 w/w % to 50 w/w %, preferably 0.1 w/w % to 30 w/w %, and more preferably 0.1 w/w % to 20 w/w %, based on the total weight of the dry powder. For perfumes such as citrus essential oils, plant essential oils, oily extracts and oleoresins thereof, synthetic perfume compounds, and oily composite perfume powders, alternatively, trehalose is appropriately added within a range of 1 to 100 parts by mass, more preferably 0.1 to 50 parts by mass, per one part by mass of perfume.

Trehalose may be mixed with the “liquid material which contains a savory and flavorful component” in such a manner that both of them are prepared into a mixture solution state before spray drying or, alternatively, the “liquid material which contains a savory and flavorful component” and a “trehalose solution” may simultaneously sprayed together during spray drying. Further, a “trehalose solution” may be sprayed on the powder formed by spray drying the “liquid material which contains a savory and flavorful component” (liquid material), as a coating agent and a binding agent and/or is then granulated, satisfactorily. If necessary, further additives, other than trehalose may be added.

The operation conditions of the spray dryer and the spray drying granulation apparatus for use in accordance with the present invention, such as outlet temperature and outlet relative humidity, are as described above. A liquid material containing trehalose is prepared into the form of microfine liquid droplets (particles) having a mean particle size (Mean Volume Diameter) of for example 0.1 μm or more to less than 20 μm, preferably 0.1 μm to 10 μm, and more preferably 1 μm to 8 μm, so that the liquid droplets can be instantly dried and granulated. Because of the instant drying at a low temperature, it is thought that the trehalose is then at amorphous state. Thus, the material which contains a savory and flavorful component and, preferably, a hygroscopic component is retained in the co-presence of trehalose and is prepared into a material with excellent solubility. Furthermore, trehalose provides the effect of preventing solidification as an excipient, so the resulting dry powder is stable under storage for a long term.

For the production of a dry powder from a liquid material which contains a savory and flavorful component and, preferably, a hygroscopic component in such manner, the liquid material is spray dried in a particle state, using a dehumidified gas at a low temperature. Compared with production methods of the related art, the savory and flavorful component can be retained and, additionally, the hygroscopic substance can be readily dried, so that a spray dry powder with good solubility can be produced on a mass scale, without thermal deterioration.

The dry powder thus produced in such a manner can be used as it is or as an intermediate material in the fields of food products and perfume. For example, the dry powder can be used as it is in powders and tablets. Additionally, the dry powder can be used in foods and drinks, such as soup stock, curry roux, mixture of dry and minced seaweed, small fishes, and sesame seed and the like (“furikake” in Japanese), Chinese soup stock, soy sauce-based soup for tempura (a recipe of frying vegetables, fishes, etc.), noodle soup, broth, mirin (sweet sake), drinks, powdered drinks, dessert, creams, cakes, chocolate, chewing gum, caramels, snacks, ice sherbets, tablet sweets, fishery processed foods, cattle processed foods, and retort foods.

The method of the present invention has a wide range of applications such as application to oils and fats without any content of savory and flavorful components or hygroscopic components. Therefore, powdered oily materials of higher quality and long-term stable storability can be produced, using the spray dryer (granulation apparatus) and the spray dry (granulation) conditions capable of generating the microfine liquid droplets of the present invention, by adding synthetic surfactants such as sucrose fatty acid ester, glycerin fatty acid ester, and polyglycerin fatty acid ester, and excipients such as trehalose to fats and oils and functional oily materials.

The spray drying described in JP-A-9-187249 is carried out according to the spray drying method of the present invention.

Other features of the invention will become apparent in the course of the following descriptions of exemplary embodiments which are given for illustration of the invention and are not intended to be limiting thereof.

### EXAMPLES

### Example 1

Refined soy sauce (tamari soy sauce) having a solid content of 42 wt. % (Ichibiki soy sauce K-85) was dried and granulated using a “HGL-130 type as granulation apparatus on filter cloth with spray drying function equipped” manufactured by Fujisaki Electric Co., Ltd. The flow of hot air, dehumidified to a relative humidity of 1% RH at 25° C. (produced by dehumidifier BX-600 type manufactured by Munsters K.K.), was set to 3.4 m³/min (filtration rate of about 2 m/min), the inlet temperature of the hot air was set to 80 to 83° C., the feed rate of the refined soy sauce was set to 1.75 to 1.93 kg/hr, the exhaust gas temperature (outlet temperature) was 44 to 45° C., and the exhaust gas humidity (outlet relative humidity) was 7 to 8% RH. A microfine dry powder (single particle) having a mean particle size of about 3 μm was generated, which was then densified under pressure and granulated on the filter membrane for particle collection. The final product was a dry granulated powder of the refined soy sauce, which had a moisture content of 1.9% (Karl-Fisher titration method) and a mean particle size (Mean Volume Diameter) of 33 μm. The measured mean particle size of the “microfine dry powder (single particle)” was a visual estimate made with the aid of a microscope. The mean particle size (Mean Volume Diameter) of the “granulated dry powder (of the refined soy sauce)” was measured as a particle size distribution by the wet mode using ethyl alcohol (at a purity of 99.5%) with a “laser diffraction & scattering particle size analyzer (manufactured by Honeywell, Co., Ltd.) connected with a microtruck ASVR (automatic small-volume circulator).” In the following Examples 2 and 3 and Comparative Example 1, the same measurement methods were used.

### Example 2

Adding trehalose dehydrate under product name “Treha” (manufactured by Hayashibara Co., Ltd.) at an amount corresponding to 10 wt. % of the solid in the refined soy sauce of Example 1, a raw material having a solid concentration of 44.6 wt. % was prepared. By using the “HGL-130 type as granulation apparatus on filter cloth with spray drying function equipped” manufactured by Fujisaki Electric Co., Ltd., with the flow of hot air, dehumidified to a relative humidity of 1% RH at 25° C. (produced by a dehumidifier BX-600 type manufactured by Munsters K.K.), set to 3.4 m³/min (filtration rate of about 2 m/min), the inlet temperature of the hot air set to 81 to 83° C., the feed rate of the raw material set to 1.8 to 2.2 kg/hr, the exhaust gas temperature was 44 to 47° C., and the exhaust gas humidity was 8% RH, a microfine dry powder (single particle) having a mean particle size of about 3 μm was generated, which was then densified under pressure and granulated on the filter membrane for particle collection. The final product was a dry granulated powder of the refined soy sauce, which had a moisture content of 2.7% (Karl-Fisher titration method) and a mean particle size (Mean Volume Diameter) of 37 μm.

### Example 3

Adding trehalose dehydrate under product name “Treha” (manufactured by Hayashibara Co., Ltd.) at an amount corresponding to 5 wt. % of the solid in the refined soy sauce of Example 1, a raw material having a solid concentration of 43.2 wt. % was prepared. By using the “HGL-130 type as granulation apparatus on filter cloth with spray drying function equipped” manufactured by Fujisaki Electric Co., Ltd., with the flow of hot air, dehumidified to a relative humidity of 1% RH at 25° C. (produced by a dehumidifier BX-600 type manufactured by Munsters K.K.), set to 3.4 m³/min (filtration rate of about 2 m/min), the inlet temperature of the hot air set to 81 to 83° C., and the feed rate of the raw material set to 1.8 to 2.1 kg/hr, the exhaust gas temperature was 45 to 49° C. and the exhaust gas humidity was 8% RH, a microfine dry powder (single particle) having a mean particle size of about 3 μm was generated, which was then densified under pressure and granulated on the filter membrane for particle collection. The final product was a dry granulated powder of the refined soy sauce, which had a moisture content of 2.1% (Karl-Fisher titration method) and a mean particle size (Mean Volume Diameter) of 34 μm.

### Comparative Example 1

With a spray dyer with an internal fluid layer using conditions of the hot air inlet temperature being 160 to 180° C. and the exhaust gas temperature being 95° C., a microfine particle dry powder of refined soy sauce having a mean particle size (Mean Volume Diameter) of about 30 μm was prepared and then granulated in the internal fluid layer, to prepare a dry powder of the granulated soy sauce having a mean particle size (Mean Volume Diameter) of about 120 μm as the final granulated product.

The products of Examples 1 through 3 and Comparative Example 1 were evaluated for their savor, flavor, burned odor, solubility, and solidification properties. The results are shown in Table 1. Specifically, all of the dry powders of Examples 1 through 3 still retained the flavor of fresh refined soy sauce (Ichibiki refined soy sauce) with great savor, and were apparently better powders than the spray dried product obtained by drying at a high temperature (Comparative Example 1).

Further, the powders of refined soy sauce of Examples 1 through 3 retained more of the soy sauce-specific savor and flavor, as compared with vacuum dried products. Furthermore, the powders of refined soy sauce of Examples 1 through 3 were all readily soluble and instantly solubilized, so these powders were satisfactory food products.

TABLE 1
Results of assessment of powdered soy sauce

| | | | | Comparative |
|---|---|---|---|---|
| Items | Example 1 | Example 2 | Example 3 | Example 1 |
| Savor retention | 3 | 3 | 3 | 2 |
| Flavor retention | 4 | 4 | 4 | 2 |
| Degree of burned odor | 5 | 5 | 5 | 4 |
| Solubility | 5 | 5 | 5 | 5 |
| Solidification level | 4 | 5 | 5 | 5 |
| Total score | 21 | 22 | 22 | 18 |

With respect to the assessed scores, by the assessment, the following scores were assigned:

“Savor retention and flavor retention”: by ranking fresh soy sauce at 5, the following scores were designated: 4: relatively good; 3: normal; 2: slightly poor; 1: poor.

“Degree of burned odor”: 5: none; 4: almost none; 3: slight smell; 2: fair smell; 1: bad smell.

“Solubility”: 4: easy dissolution 3: normal; 2: difficulty in dissolution; 1: hardly dissolving.

“Solidification level” (after standing alone in sealed state for one week): 4: no solidification; 3: normal; 2: slight solidification; 1: much solidification.

For the production of a dry powder from a liquid material which contains a savory and flavorful component and, preferably, a hygroscopic component by the method of the present invention, the liquid material is prepared into a microfine liquid droplet state and is spray dried under dehumidified conditions at low temperature, namely the outlet temperature of the spray dryer is 20 to 90° C. and the outlet relative humidity is 1% RH to 40% RH, so that a dry powder which contains a savory and flavorful component superior to conventional products may be readily obtained. Further, dry powders which contain trehalose, as an excipient for hygroscopic components and the like, can retain the savor and flavor and provide the additional effect of preventing solidification and exhibit great solubility. Therefore, the present method can provide processed food products of high quality and with improved savor and flavor.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing a dry powder, said method comprising:
(1) spray drying a hydrous liquid in a state of microfine liquid droplets in a gas atmosphere in a spray dryer, to obtain a dry powder,
wherein said spray dryer has an outlet temperature of 20 to 90° C. and an outlet relative humidity of 1% RH to 40% RH, and said dry powder has a mean particle size of 0.1 μm to 15 μm.

2. The method of claim 1, wherein said hydrous liquid comprises a savory and flavorful component.

3. The method of claim 2, wherein said hydrous liquid comprises a hygroscopic component.

4. The method of claim 3, wherein said hygroscopic component is said savory and flavorful component.

5. The method of claim 1, wherein said hydrous liquid is a solution.

6. The method of claim 1, wherein said hydrous liquid is a slurry.

7. The method of claim 1, wherein said hydrous liquid is an emulsion.

8. The method of claim 1, wherein said hydrous liquid is spray dried in the presence of trehalose.

9. The method of claim 8, wherein said trehalose is added to said hydrous liquid prior to spray drying.

10. The method of claim 8, wherein said trehalose is prepared into the form of a trehalose solution in a microfine liquid droplet state which is separate from said hydrous liquid and said trehalose solution is spray dried simultaneously with said hydrous liquid.

11. The method of claim 1, wherein said the hydrous liquid is at least one liquid selected from the group consisting of moisture-containing food materials, drinks, liquid seasonings, curry-containing fluids, mustard-containing fluids, Japanese horseradish-containing fluids, garlic-containing fluids, ginger-containing fluids, and mixtures thereof.

12. The method of claim 1, wherein said hydrous liquid is a soy sauce-based liquid seasoning.

13. The method of claim 1, wherein said hydrous liquid is at least one liquid selected from the group consisting of citrus essential oils, plant essential oils, oily extracts and the oleoresins thereof, synthetic perfume compounds, oily composite perfumes, and mixtures thereof.

14. The method of claim 1, wherein said outlet temperature of said spray dryer is 20 to 75° C.

15. The method of claim 1, wherein said outlet relative humidity of a spray dryer is 3% RH to 20% RH.

16. The method of claim 1, wherein said outlet relative humidity of said spray dryer is 6% RH to 10% RH.

17. A dry powder, produced by the method of claim 1.

18. A method for producing a granulated powder, said method comprising:
(1) spray drying a hydrous liquid material in a microfine liquid droplet state in gas atmosphere in a spray drying granulation apparatus, to obtain a dry powder; and
(2) granulating said dry powder either during or after said spray dying, to obtain a granulated powder,
wherein said spray drying granulation apparatus has an outlet temperature of 20 to 90° C. and an outlet relative humidity of 1% RH to 40% RH, and said granulated powder has a mean particle size of 20 μm to 1,000 μm.

19. The method of claim 18, wherein said hydrous liquid comprises a savory and flavorful component.

20. The method of claim 18, wherein said hydrous liquid comprises a hygroscopic component.

21. The method of claim 18, wherein said hygroscopic component is said savory and flavorful component.

22. The method of claim 18, wherein said hydrous liquid is a solution.

23. The method of claim 18, wherein said hydrous liquid is a slurry.

24. The method of claim 18, wherein said hydrous liquid is an emulsion.

25. The method of claim 18, wherein said hydrous liquid is spray dried in the presence of trehalose.

26. The method of claim 25, wherein said trehalose is added to said hydrous liquid prior to spray drying.

27. The method of claim 25, wherein said trehalose is prepared into the form of a trehalose solution in a microfine liquid droplet state which is separate from said hydrous liquid and said trehalose solution is spray dried simultaneously with said hydrous liquid.

28. The method of claim 18, wherein said the hydrous liquid is at least one liquid selected from the group consisting of moisture-containing food materials, drinks, liquid seasonings, curry-containing fluids, mustard-containing fluids, Japanese horseradish-containing fluids, garlic-containing fluids, ginger-containing fluids, and mixtures thereof.

29. The method of claim 18, wherein said hydrous liquid is a soy sauce-based liquid seasoning.

30. The method of claim 18, wherein said hydrous liquid is at least one liquid selected from the group consisting of citrus essential oils, plant essential oils, oily extracts and the oleoresins thereof, synthetic perfume compounds, oily composite perfumes, and mixtures thereof.

31. The method of claim 18, wherein said outlet temperature of said spray drying granulation apparatus is 20 to 75° C.

32. The method of claim 18, wherein said outlet relative humidity of a spray drying granulation apparatus is 3% RH to 20% RH.

33. The method of claim 18, wherein said outlet relative humidity of said spray drying granulation apparatus is 6% RH to 10% RH.

34. A granulated powder, produced by the method of claim 18.

35. A method for producing a dry granulated powder, said method comprising:
(1) spray drying a hydrous liquid material in a microfine liquid droplet state in gas atmosphere in a spray drying granulation apparatus, to obtain a powder;
(2) granulating said powder either during or after said spray dying, to obtain a granulated powder; and
(3) drying said granulated powder, to obtain a dry granulated powder,
wherein said spray drying granulation apparatus has an outlet temperature of 20 to 90° C. and an outlet relative humidity of 1% RH to 40% RH, and said dry granulated powder has a mean particle size of 20 μm to 1,000 μm.

36. A 12. A dry granulated powder, produced by the method of claim 35.
